(19) United States
(12) Patent Application Publication
(10) Pub. No.: US 2026/0321523 A1
(43) Pub. Date: Oct. 15, 2026

(54) POWER DISTRIBUTION UNIT

(71) Applicant: MAGNA Powertrain GmbH & Co KG, Lannach (AT)

(72) Inventors: Michael SCHNEIDER, Herrenberg (DE); Andreas KURZ, Öhringen (DE); Marcel BRESK, Stuttgart (DE)

(21) Appl. No.: 19/368,339

(22) Filed: Oct. 24, 2025

(30) Foreign Application Priority Data
Nov. 8, 2024 (DE) 102024132576.3

(51) Int. Cl. H01H 3/38

(52) U.S. Cl. CPC H01H 3/38

(57) ABSTRACT

A power distribution unit having at least two electrical connection regions, including at least one first electrical connection region and at least one second electrical connection region. The first electrical connection region has at least one fixed first electrical contact element and the second electrical connection region has at least one fixed second electrical contact element such that the first electrical contact element and the second electrical contact element are able to be electrically connected and disconnected via at least one movable third electrical contact element. The third electrical contact element is biased into a switching setting via at least one elastic element and is able to be actuated into at least one different switching setting via an actuator unit. The actuator unit has at least one actuator and at least one switching shaft, which is able to be moved via the actuator and, on the basis of the actuated switching setting, leaves the third electrical contact element in the biased switching setting, or moves it into at least one different switching setting counter to the spring force of the elastic element. The switching shaft drives a switching wheel via a driving wheel and wherein the switching wheel-driving wheel combination constitutes a step gear.

### CROSS-REFERENCE TO RELATED APPLICATIONS

This application claims priority to German Application No. DE 102024132576.3 filed Nov. 8, 2024. The entire disclosure of the above application is incorporated herein by reference.

### FIELD OF THE INVENTION

The invention relates to a power distribution unit having at least two electrical connection regions, including at least one first electrical connection region and at least one second electrical connection region, wherein the first electrical connection region has at least one fixed first electrical contact element and the second electrical connection region has at least one fixed second electrical contact element, wherein the first electrical contact element and the second electrical contact element are able to be electrically connected and disconnected via at least one movable third electrical contact element, wherein the third electrical contact element is biased into a switching setting via at least one elastic element and is able to be actuated into at least one different switching setting via an actuator unit, wherein the actuator unit has at least one actuator and at least one mechanical interface to a switching shaft, which is able to be moved via the actuator and, on the basis of the actuated switching setting, leaves the third electrical contact element in the biased switching setting, or moves it into at least one different switching setting counter to the spring force of the elastic element.

### BACKGROUND OF THE INVENTION

This section provides information related to the present disclosure which is not necessarily prior art.

Power distribution units for motor vehicles, in particular for hybrid motor vehicles or electric motor vehicles, have, in addition to fuse units and voltage measurement systems and current measurement systems, switching arrangements that prevent or enable the flow of electricity through an electrical power circuit of the vehicle.

In general, these switching arrangements are constructed from at least three relays—depending on the design, at least two high-current relays and one precharging relay are installed. In some cases, further relays for turning on and off drive units, DC charging contacts, a battery bank switchover and for fulfilling other functions may also be installed.

The relays used each consist of a contact and an actuator, which are activated by corresponding output stages of a control device and monitored via specific circuits.

In addition to the high costs, using a plurality of individual relays and actuators also results in an increased requirement for installation space and increased weight. Furthermore, the relays themselves usually have two high-current connections, which can be cooled only passively via the attached busbars. This has a disadvantageous effect on installation space and weight of the contact technology. The demand for current-carrying capacity and closing speed and opening speed also requires adaptation of the actuators. This has a disadvantageous effect on the total weight, the total volume and the energy efficiency. It additionally results in complex control and monitoring systems for each individual relay, in order to identify or prevent malfunctions that occur. The sum of all these disadvantages results in the desire for an improved switching arrangement, which is suitable for use in a power distribution unit of a battery-electric vehicle.

The HV relays used are generally structurally identical and each consist of a contact and an actuator that are activated by corresponding output stages of a control device and monitored via specific circuits. Each one of these relays has the necessary integrated technology to interrupt the flow of current even under load conditions.

From the unpublished DE 10 2023 209 219, a switching arrangement is known. This has a camshaft or crankshaft as the central actuating element for actuating the contacts. Depending on the number of switching settings, there are various switching positions of the actuating shaft. Since it is a spring-loaded unit, it is important that the contacts and the shaft stay in the defined switching position. The springs are subject to external environmental influences such as vibrations and acceleration peaks, and therefore a mechatronic actuation design for the camshaft or crankshaft is necessary, so that the switching position of the individual switches remains securely connected or open.

Due to the demand for switching under load in certain situations, the contacts of the switches must open or close within a defined time, since otherwise excessive arc formation occurs at the contacts. This arc formation leads to wear on the components.

### SUMMARY OF THE INVENTION

This section provides a general summary of the present invention, and is not a comprehensive disclosure of its full scope or all of its features.

It is an object of the invention to provide an improved electromechanical switching arrangement, wherein the switches are connected securely and simply.

The object is achieved with a power distribution unit having at least two electrical connection regions, specifically at least one first electrical connection region and at least one second electrical connection region, wherein the first electrical connection region has at least one fixed first electrical contact element and the second electrical connection region has at least one fixed second electrical contact element, wherein the first electrical contact element and the second electrical contact element are able to be electrically connected and disconnected via at least one movable third electrical contact element, wherein the third electrical contact element is biased into a switching setting via at least one elastic element and is able to be actuated into at least one different switching setting via an actuator unit, wherein the actuator unit has at least one actuator and at least one mechanical interface to a switching shaft, which is able to be moved via the actuator and, on the basis of the actuated switching setting, leaves the third electrical contact element in the biased switching setting, or moves it into at least one different switching setting counter to the spring force of the elastic element, wherein the actuator unit drives a switching wheel via a driving wheel and wherein the switching wheel-switching shaft combination constitutes a step gear.

The solution causes the switching shaft to rotate by a defined angular value along the actuation path. This can be performed variably using the geometry and requirement for switching settings, 30°, 60°, 90° steps. The solution additionally ensures that the camshaft is held in a defined position. An additional holding force by an electrical actuator can be omitted.

The switching wheel has an outer contour with concave blade surfaces between grooves and blade tips.

The groove distribution runs at equal or unequal intervals radially toward the pivot point of the switching wheel.

The driving wheel has a journal for engaging in the grooves of the switching wheel and a convex contour for supporting the concave blade surfaces of the switching wheel.

The cams of the switching shaft press the third contact element against the spring force of the elastic element.

The elastic element is a compression spring, preferably a leaf spring or a coil spring.

By actuating a power distribution unit the journal engages by rotating the driving wheel in a groove of the switching wheel and rotates said switching wheel, wherein upon further rotation the journal slides out of the groove and the switching wheel rotates into a starting position again, in which the switching wheel is supported on the driving wheel by a convex surface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a power distribution unit.

FIG. 2 shows a cross-section along the line A-A.

FIG. 3 shows an embodiment of a circuit according to the invention.

FIG. 4 shows the switching sequence of the embodiment.

### DESCRIPTION OF THE INVENTION

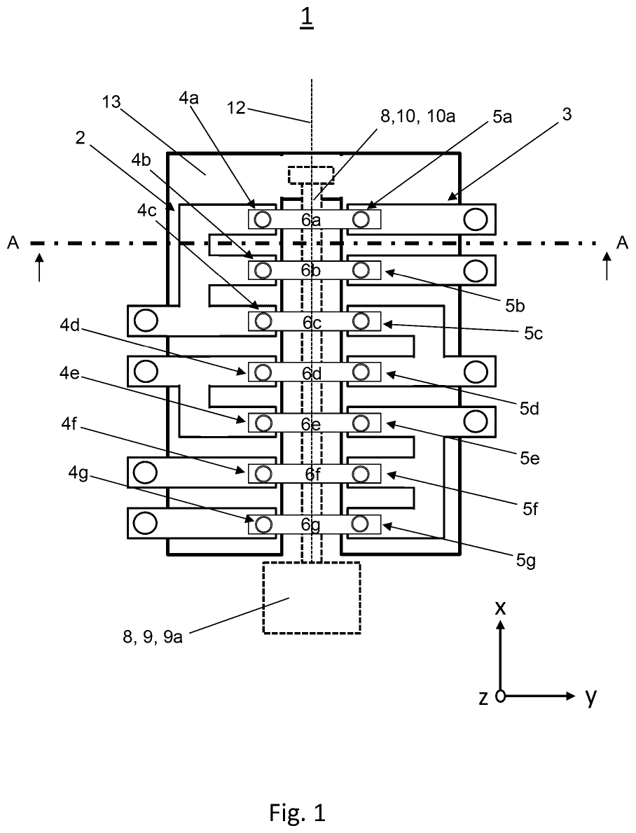

The basis of the invention is a power distribution unit, which will be described by way of example using FIG. 1.

An embodiment variant of the electromechanical switching arrangement 1 is depicted in FIG. 1. The electromechanical switching arrangement 1 has a first electrical connection region 2 and a second electrical connection region 3. The first electrical connection region 2 and the second electrical connection region 3 are arranged next to one another on a cooling unit 13 in a first constructional plane X.

The first electrical connection region 2 has a plurality of fixed first electrical contact elements 4a-4g, specifically seven first electrical contact elements 4a-4g.

The second electrical connection region 3 has a plurality of fixed second electrical contact elements 5a-5g, specifically seven second electrical contact elements 5a-5g.

A respective first electrical contact element 4a-4g of the first electrical connection region 2 is able to be connected to, and disconnected from, a respective second electrical contact element 5a-5g of the second connection region 3 via a respective third contact element 6a-6g.

For this purpose, the respective third contact element 6a-6g is able to be controlled into two switching settings A, B, specifically into a first switching setting A and into a second switching setting B, via an actuator unit 8.

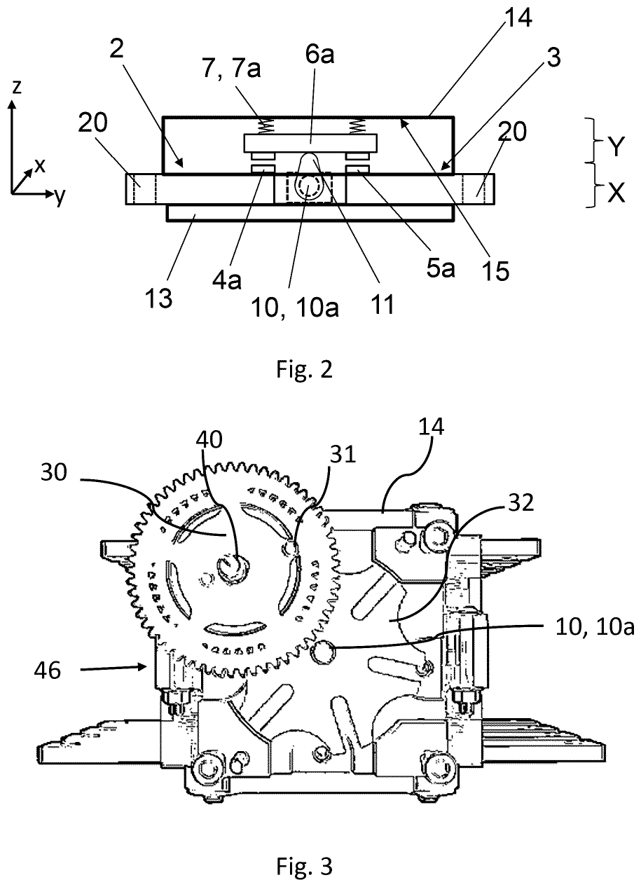

In the embodiment variant according to FIG. 1 and FIG. 2, the first switching setting A corresponds to a switching setting in which a respective first electrical contact element 4a-4g is electrically connected to a respective second electrical contact element 5a-5g via a respective third electrical contact element 6a-6g.

In the embodiment variant according to FIG. 1, the second switching setting B corresponds to a switching setting in which a respective first electrical contact element 4a-4g is electrically disconnected from the respective second electrical contact element 5a-5g, as depicted in FIG. 2.

The actuator unit 8 comprises an actuator 9, which is designed as an electric motor 9a, and a switching shaft 10 with a plurality of switching elements 11, specifically seven switching elements 11. The switching shaft 10 is formed as a camshaft 10a and the individual switching elements 11 of the switching shaft 10 are formed by cams secured to the camshaft 10a.

In each case, a switching element 11 of the switching shaft 10 is functionally assigned in each case to a third electrical contact element 6a-6g.

The switching shaft 10 is also arranged in the first constructional plane X in a region between the first electrical connection region 2 and the second electrical connection region 3 and extends axially between the two electrical connection regions 2, 3.

The directional indication “axial” is to be understood as a direction along or parallel to the central longitudinal axis 12 of the switching shaft 10.

The first electrical connection region 2 and the second electrical connection region 3 are partially arranged in a housing 14, and specifically in such a way that the first electrical contact elements 4a-4g and the second electrical contact elements 5a-5g are arranged inside the housing 14 and connection points 20 of the respective electrical connection region 2, 3 are formed outside the housing 14.

Respective connection points 20 are electrically connected in each case to at least one respective first or second electrical contact element 4a-4g, 5a-5g of the respective connection region 2, 2′, 3, 3′.

The switching shaft 10 is mounted substantially in the housing 14 and is designed to be able to be driven rotatably via the electric motor 9a arranged outside the housing 14.

The third electrical contact elements 6a-6g are arranged on an inner wall 15 of the housing 14 in a second constructional plane Y via in each case two elastic elements 7, specifically compression springs 7a in the present case, and specifically in such a way that in each case a third electrical contact element 6a-6g is arranged substantially parallel to the two electrical connection regions 2, 3 with the respective electrical contact elements 4a-4g, 5a-5g thereof.

The second constructional plane Y corresponds to a spatial plane parallel to the first constructional plane X.

The third electrical contact elements 6a-6g and the camshaft 10a are arranged in such a way that, in each case, a cam of the camshaft 10a in each case can control a third electrical contact element 6a-6g into the two switching settings A, B.

In the first switching setting A, a respective first electrical contact element 4a-4g is electrically connected to a respective second electrical contact element 5a-5g via a respective third electrical contact element 6a-6g. This is attained in the embodiment variant depicted in FIG. 1 and FIG. 2 by biasing the respective third contact element 6a-6g, via the springs 7a, radially in the direction of the respective first electrical contact element 4a-4g assigned thereto and of the respective second electrical contact element 5a-5g assigned thereto, therefore into a closed setting.

In the second switching setting B, see FIG. 2, a respective first electrical contact element 4a-4g is electrically disconnected from the respective second electrical contact element 5a-5g, by moving the assigned respective third contact element 6a-6g, via the cams assigned thereto of the camshaft 10a, radially counter to the spring force of the springs 7a in the direction of the inner wall 15 of the housing 14 and thus bringing about an open setting.

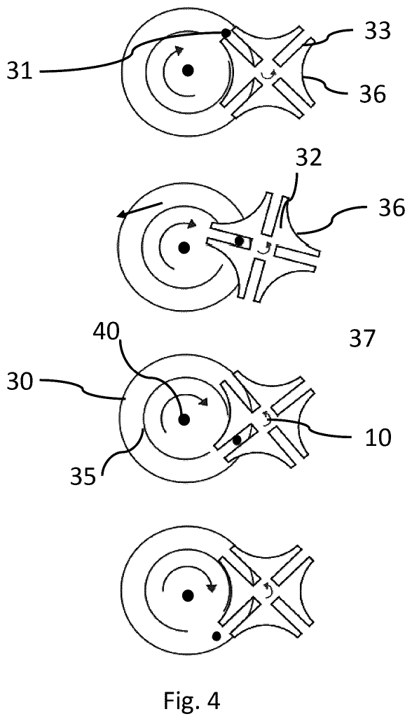

In the first switching setting A, a respective first electrical contact element 4a-4g is electrically connected to a respective second electrical contact element 5a-5g via a respective third electrical contact element 6a-6g. In the embodiment according to the invention according to FIG. 3 and FIG. 4, the actuator unit 8 comprises an actuator 9 that can be designed as a DC motor, BLDC motor, stepper motor or other rotation machines.

The actuator unit 8 furthermore comprises an interconnected gear that can be designed in the form of a spur gear, planetary gear or other transmission gears and achieves a gear reduction for the electric motor of the actuator 9. Downstream of this gear there is a step gear that constitutes a type of intermittent movement device.

FIG. 3 shows a view of the end face of the power distribution unit, wherein only parts of the actuator unit 8 are depicted. The actuator unit 8 comprises a driving wheel 30, which is connected to the actuator 9 via the interconnected gear. The driving wheel 30 is mounted in the end-face region of the housing 14 and rotates around the axis 40. The switching shaft 10 is also mounted in the end-face region of the housing 14.

FIG. 4 shows the sequence during operation, but in a view of the rear side of the driving wheel 30 of FIG. 3.

The driving wheel 30 possesses a journal 31 and has an edge 35 that runs in an inwardly offset manner radially in relation to the axis of rotation. The edge 35 forms a convex circular segment, which enables engagement on a switching wheel 32. As a result, the defined switching position is fixed using geometry. No additional holding force from outside is required.

The switching wheel 32, formed like a Maltese cross, has equally distributed grooves 33 on its circumference. The switching wheel 32 sits on the switching shaft 10.

In the exemplary embodiment in FIG. 4, four grooves 33 run offset by 90 degrees in relation to one another in the direction of the axis of rotation of the switching wheel 32, therefore toward the switching shaft 10. To latch the switching position, the switching wheel 32 possesses circular-segment-like recesses at the circumference between the grooves 33, which recesses form concave blade surfaces 36.

The driving wheel 30 and the switching wheel 32 together form the step gear 46. The switching procedure is depicted in FIG. 4. Beginning from the top, the switching wheel 32 is in a position in which one of the concave blade surfaces rests on the edge 35 of the switching wheel 32 and the journal 31 specifically is not yet accommodated in one of the grooves 33.

When the driving wheel 30 rotates, the raised journal 31 engages in one of the grooves 33 on the switching wheel 32. While the driving wheel 30 continues to rotate, the journal 31 moves along one of the grooves 33, with the result that the switching wheel 32 rotates by a fixed angular value-typically in integer increments of 360°. This can be seen in the second image from the top in FIG. 4. As a result, the switching wheel 32 rotates counter to the driving wheel 30. Connecting the switching wheel 32 to the switching shaft 10 results in a twisting of the switching shaft and thus of the cams on the switching shaft. The movement of the cams brings about the opening and closing of the contact elements 6a-6g. In the third image from the top in FIG. 4, the further course of the rotation can be seen, with the switching wheel 32 rotating further and again seeking the position in which the concave blade surface 36 is situated opposite the edge 35 of the driving wheel 30.

As soon as the journal 31 reaches the end of the groove 33, it is released from the switching wheel 32, which leads to a pause in movement or an intermittent movement. The edge 35 of the driving wheel, formed as a convex circular segment, engages the switching wheel, see lowermost image in FIG. 4. As a result, the defined switching position is fixed using geometry. No additional holding force from outside is required. Furthermore, the dynamic of the position regulation can be improved. Overshooting of the actuator no longer has an influence on the angular position of the switching shaft, since this is already fixed via the engaging circular segment.

The movement sequence remains the same for further switching settings, wherein the journal 31 engages in further grooves 33 on the switching wheel in each case. It is also irrelevant whether the driving wheel is rotated clockwise or counter-clockwise. In fact, this enables discrete and repeatable closing and opening of the contacts of the electromechanical switching arrangement.

What is claimed is:

1. A power distribution unit having at least two electrical connection regions, including at least one first electrical connection region and at least one second electrical connection region, wherein the first electrical connection region has at least one fixed first electrical contact element and the second electrical connection region has at least one fixed second electrical contact element, wherein the first electrical contact element and the second electrical contact element are able to be electrically connected and disconnected via at least one movable third electrical contact element, wherein the third electrical contact element is biased into a switching setting via at least one elastic element and is able to be actuated into at least one different switching setting via an actuator unit, wherein the actuator unit has at least one actuator and at least one mechanical interface to a switching shaft which is able to be moved via the actuator and, on the basis of the actuated switching setting, leaves the third electrical contact element in the biased switching setting or moves it into at least one different switching setting counter to the spring force of the elastic element, and wherein the actuator unit drives a switching wheel via a driving wheel and wherein the switching wheel-driving wheel combination constitutes a step gear.

2. The power distribution unit as claimed in claim 1, wherein the switching wheel has an outer contour with concave blade surfaces between the grooves and blade tips.

3. The power distribution unit as claimed in claim 2, wherein the groove distribution runs at equal or unequal intervals radially toward the pivot point of the switching wheel.

4. The power distribution unit as claimed in claim 2, wherein the driving wheel has a journal for engaging in the grooves of the switching wheel and a convex contour for supporting the concave blade surfaces of the switching wheel.

5. The power distribution unit as claimed in claim 1, wherein the cams of the switching shaft press the third electrical contact element against the spring force of the elastic element.
